(19) United States
(12) Patent Application Publication
(10) Pub. No.: US 2010/0178226 A1
(43) Pub. Date: Jul. 15, 2010

(54) Method for removing methane for gas mixtures

(75) Inventors: Michiel Makkee, Rockanje (NL); Xiao Ding Xu, Schiedam (NL)

Correspondence Address: FITCH, EVEN, TABIN & FLANNERY, P. O. BOX 18415, WASHINGTON, DC, 20036, US

(73) Assignee: Technische Universiteit Delft, Delft (NL)

(21) Appl. No.: 12/310,520

(22) PCT Filed: Aug. 29, 2007
(86) PCT No.: PCT/NL2007/050426

§ 371 Date: Jun. 19, 2009

(30) Foreign Application Priority Data
Aug. 30, 2006 (NL) 1032393

(51) Int. Cl. B01D 53/72; B01J 23/42; B01J 21/18; B01J 23/89

(52) U.S. Cl. 423/245.1; 502/326; 502/184

(57) ABSTRACT

The invention relates to a method for oxidizing methane, including passing a gaseous, methane-containing mixture over a catalyst, wherein a carrier with a substrate surface consists substantially of titanium dioxide with a combination of platinum and palladium thereon, in the presence of molecular oxygen, and to a catalyst suitable thereto.

The invention relates to a method for removing methane from gas mixtures, and to a methane oxidation catalyst on carrier for removing methane through oxidation from the flue gases of a gas and/or biogas engine, simultaneously adsorbing any sulphur compounds that may be present.

There is an increasing need for methods for purifying, to an extensive degree, flue gases of engines, more particularly (bio)gas engines. As a rule, these flue gases still contain residues of organic compounds, such as methane, and residues of sulphur compounds. For further use of the flue gases as, for instance, source of CO₂ in greenhouses, it is desired that the flue gases contain, as contaminants, as little organic compounds as possible, while also, the sulphur compounds content should be as low as possible. For the emission of the flue gases to the atmosphere as well, it is desired that the contaminant content is as low as possible.

Many gas engines exhibit some degree of leakage of the fuel gases, most often biogas or methane. It is therefore usual to treat the flue gases further by passing them over an oxidation catalyst. A suitable catalyst which is also reasonably active at low temperatures is a palladium catalyst, which is preferably arranged on a carrier whose surface has been modified with titania (titanium oxide).

Wang et al. (Low temperature complete combustion of methane over titania modified alumina supported palladium, Fuel 81 (2002) 1883-1887) describes the positive effect of titania on the action of a palladium catalyst on the oxidation of methane at a temperature of less than 700° C., with, proportionally, higher methane contents and long residence times.

It is preferred that a combination of removing organic compounds and removing sulphur compounds is sought. Systems are commercially available with which, on the one side, the organic compounds (methane) are oxidized and, on the other side, the sulphur compounds are adsorbed. Such a system is based on a monolith, provided with a titania coating, with platinum and copper applied thereon. At low temperatures, the activity of this catalyst for the oxidation of methane is, however, quite low, while also, the resistance against temperature fluctuations is limited. Hence, there is a need for a system which is active at comparatively low temperatures, i.e. from approximately 400° C., and which, also after cooling down and heating up again, still exhibits a good activity. There is also a need for a system which, with low concentrations of reactants (oxygen and methane) and with a short contact time (high GHSV) gives a good conversion of methane (and other organic compounds).

Surprisingly, it has appeared that the use of a combination of platinum and palladium is particularly effective for obtaining these results. The invention therefore relates to a method for oxidizing methane, comprising passing a gaseous, methane containing mixture over a catalyst comprising a carrier with a substrate surface which consists substantially of titanium oxide with a combination of platinum and palladium thereon, in the presence of molecular oxygen.

The invention further relates to an oxidation catalyst, comprising a carrier with a substrate surface which consists substantially of titanium oxide with a combination of platinum, palladium and copper thereon.

As appears from the examples, only the combination of platinum with palladium has this positive effect. Combinations of platinum with other metals, such as nickel, zirconium, cobalt or tin do not exhibit these effects.

The catalyst is provided on a carrier, whose surface consists substantially of titania. This can, therefore, be a carrier consisting exclusively of titania, but it is also possible that a carrier is used whose surface consists substantially of titania, for instance a solid oxidic carrier, metal or active carbon, having on the surface thereof a layer of titania. As a carrier, preformed particles, powder or extrudates can be taken as starting point, but also a structured carrier, such as a monolith with a wash coat of titania or a metal or a ceramic foam with such a wash coat.

The amounts of platinum and palladium can vary within broad ranges, depending on the desired use and the desired activity. The skilled person can determine these values by way of experiment. Preferably, the amounts of platinum and palladium are, independently of each other and each separately, 0.05 to 10% by weight, with a preference for the range of 0.1 to 2.5% by weight, based on the weight of the carrier and the active material. The relative weight ratio of platinum to palladium is preferably between 0.1 and 10, and is preferably 0.5-2.

It has appeared that it is possible to include, in the same catalyst, a sulphur trapping component. This component, preferably copper, zinc or nickel, removes the sulphur compounds, probably through adsorption or reaction thereof. It appears that this component has no negative influence on the action of the oxidation and possibly even a positive one.

The amount of metal depends on the sulphur content of the flue gases and the desired adsorption capacity of the catalytic body. In general, the content is 1-10% by weight, more particularly 2.5 to 8% by weight. When the adsorption capacity is reached, the catalytic body can be returned to its initial condition(s) by means of a regeneration procedure.

The manufacture of the catalyst according to the invention can be done, inter alia, utilizing known techniques, such as impregnation, (deposition or incipient wetness) precipitation, or by applying a wash coat, or chemical gas phase deposition, electric spray deposition, etc.

The invention also relates to a method for oxidizing organic compounds, more particularly methane, comprising passing a gaseous mixture containing the organic compound(s) over the above-described catalyst in the presence of molecular oxygen. More in particular, the invention comes to advantage in case the amount of reactants is low, i.e., when the content of organic material is 5000 ppm or less and the oxygen content is smaller than 15 vol. %.

The invention is also very suitable for use at very high gas velocities (GHSV) of the flue gas, which implies a short residence time. It is preferred when the GHSV is between 10,000 and 50,000 h⁻¹.

Presently, the invention is elucidated on the basis of examples, which should not be construed as being limitative.

### EXAMPLES

A number of different metals were applied by means of an incipient wetness impregnation on an existing platinum copper catalyst, having as a carrier a titanium oxide covered silica. The catalyst contained 1% by weight of platinum and 5% by weight of copper.

The catalysts were dried at 800° C. and thereupon calcined for three hours at 600° C. Thus, 6 different catalysts were obtained which each contained 1% by weight of the applied metal (palladium, cobalt, nickel, tin, cerium and zirconium).

These six catalysts and the original catalyst were tested for the oxidation of methane at 1.5 bar (abs). First, the catalysts were activated for 1 hour at 250° C. with a gas stream of 20% oxygen in helium.

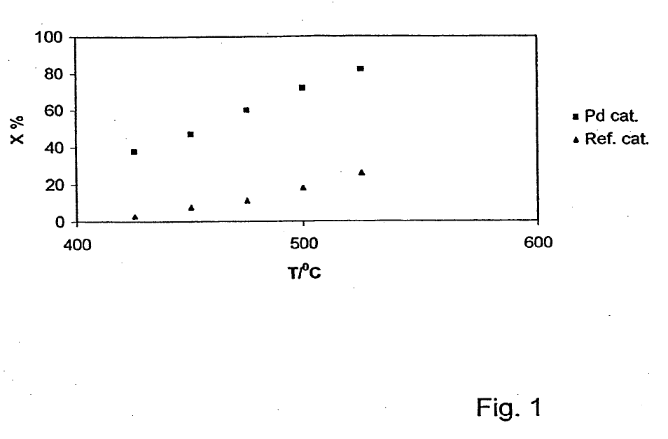

Then, 0.1 vol. % of methane and 10 vol. % of oxygen in helium were passed over the catalysts at a GHSV of 24000 h⁻¹. The activity was measured at temperatures of 250° C. to 600° C. The results are given in Tables 1 and 2 and FIG. 1.

TABLE 1
Comparison of the behaviour of the catalysts
at different temperatures.

| | | | | | | |
|---|---|---|---|---|---|---|
| | Ni cat | Co cat | Sn cat | Zr cat | Pd cat | Ref. cat |
| T/° C. | X % | X % | X % | X % | X % | X % |

Heating

| | | | | | | |
|---|---|---|---|---|---|---|
| 250 | 0 | 0.87 | 0.12 | 0.45 | 0.87 | 0.70 |
| 300 | 0.68 | 1.22 | 1.52 | 1.42 | 3.14 | 2.62 |
| 400 | 0.41 | 3.38 | 3.21 | 3.69 | 19.71 | 17.98 |
| 500 | 8.53 | 10.47 | 13.56 | 15.38 | 73.75 | 41.37 |
| 525 | 12.20 | 15.47 | 20.10 | 24.38 | 84.59 | 52.68 |
| 550 | 17.56 | 21.30 | 27.67 | 33.93 | 90.39 | 59.59 |
| 575 | 24.68 | 28.91 | 36.27 | 44.18 | 93.02 | 62.88 |
| 600 | 33.20 | 37.72 | 46.42 | 55.42 | 94.14 | 63.95 |

Cooling

| | | | | | | |
|---|---|---|---|---|---|---|
| 550 | 16.35 | 21.60 | 26.36 | 32.84 | 87.94 | 37.61 |
| 500 | 6.18 | 10.07 | 12.41 | 15.81 | 72.76 | 18.17 |
| 400 | 0.77 | 1.05 | 1.31 | 2.23 | 24.53 | 2.49 |
| X_{C}/X_{H} | 0.931 | 1.014 | 0.953 | 0.968 | 0.973 | 0.631 |
| 550° C. | | | | | | |
| X_{C}/X_{H} | 0.72 | 0.96 | 0.91 | 1.03 | 0.99 | 0.44 |
| 500° C. | | | | | | |
| X_{C}/X_{H} | 1.87 | 0.31 | 0.41 | 0.61 | 1.24 | 0.14 |
| 400° C. | | | | | | |

Conversion in %. X_{C}/X_{H} is the ratio of conversions at cooling and heating

After cooling of the catalysts to 425° C., the activity was again determined. The data thereof are included in Table 2, while in FIG. 1 a comparison is given of the activity at second heating between the reference catalysts and the original catalyst.

TABLE 2
Conversion at different temperatures at second heating.

| | Pd,Pt catalyst | | | Reference Pt catalyst | | |
|---|---|---|---|---|---|---|
| T/° C. | 2^{nd} X % | 1^{st} X % | ratio* | 2^{nd} X % | 1^{st} X % | ratio* |
| 425 | 38.08 | | | 2.97 | | |
| 450 | 47.44 | | | 7.77 | | |
| 475 | 60.34 | | | 11.43 | | |
| 500 | 72.05 | 73.75 | 0.977 | 18.1 | 41.37 | 0.438 |
| 525 | 82.23 | 84.59 | 0.972 | 26.17 | 52.68 | 0.497 |

*The second conversion divided by that of the first time.

From these experiments it clearly appears that only palladium gives an improvement of the activity. All other metals give a reduction of the activity of the platinum copper catalyst. Upon renewed use too, palladium is the only one to give a clear improvement of the activity.

1. A method for oxidizing methane, comprising passing a gaseous, methane containing mixture over a catalyst comprising a carrier with a substrate surface which consists substantially of titanium dioxide with a combination of platinum and palladium thereon, in the presence of molecular oxygen.

2. A method according to claim 1, wherein the methane content in the gaseous mixture is not more than 5000 ppm.

3. A method according to claim 1, wherein the molecular oxygen content in the gaseous mixture is not more than 15% by volume.

4. A method according to claim 1, wherein the amount of platinum is between 0.01 and 10% by weight.

5. A method according to claim 1, wherein the amount of palladium is between 0.01 and 10% by weight.

6. A method according to claim 1, wherein also copper is present on the surface, preferably in an amount between 0.1 and 10% by weight.

7. A method according to claim 1, wherein the carrier consists of one or more solid oxides or active carbon, having on the surface thereof a cover of titanium dioxide as substrate surface, while the carrier is a metal or ceramic monolith or a structured body, such as a metal or ceramic body.

8. A method for removing methane from the flue gases of a gas engine, comprising treating these flue gases with a method according to claim 1.

9. A methane oxidation catalyst, comprising a carrier with a substrate surface which consists substantially of titanium dioxide with a combination of platinum, palladium and copper thereon, wherein the carrier preferably is a metal or ceramic monolith or a structured body, such as a metal or ceramic body.

10. A catalyst according to claim 9, wherein the amount of platinum is between 0.01 and 10% by weight.

11. A catalyst according to claim 9, wherein the amount of palladium is between 0.01 and 10% by weight.

12. A catalyst according to claim 10, wherein copper is present on the surface in an amount between 0.1 and 10% by weight.

13. A catalyst according to claim 9, wherein the carrier consists of one or more solid oxides or active carbon, having on the surface thereof a cover of titanium dioxide as substrate surface.
